(19) United States
(12) Patent Application Publication
(10) Pub. No.: US 2025/0266932 A1
(43) Pub. Date: Aug. 21, 2025

(54) FRAME FORMAT GENERATION AND ANALYSIS SYSTEM AND FRAME FORMAT GENERATION AND ANALYSIS METHOD

(71) Applicant: REALTEK SEMICONDUCTOR CORPORATION, Hsinchu (TW)

(72) Inventors: LI-HUA WANG, Suzhou (CN); Feng-Xiang Wang, Suzhou (CN); Ming-Zhi Guo, Suzhou (CN)

(21) Appl. No.: 18/973,171

(22) Filed: Dec. 9, 2024

(30) Foreign Application Priority Data
Feb. 19, 2024 (CN) 202410186538.X

(51) Int. Cl. H04L 1/1607; H04W 72/0446

(52) U.S. Cl. CPC H04L 1/1642; H04W 72/0446

(57) ABSTRACT

A frame format generation and analysis system includes a transmitting device and a receiving device. The transmitting device is configured to insert a signature sequence in a physical layer convergence protocol (PLCP) preamble, insert a remaining sequence between the signature sequence and a start frame delimiter (SFD), and transmit the PLCP preamble. The receiving device is configured to receive the PLCP preamble, and analyze whether the PLCP preamble includes the signature sequence. If the PLCP preamble includes the signature sequence, the receiving device generates an activating signal for activating a user-defined protocol.

### BACKGROUND OF THE INVENTION

### 1. Field of the Invention

The present disclosure relates to a frame format generation and analysis system and a frame format generation and analysis method, especially to a frame format generation and analysis system and a frame format generation and analysis method that insert a signature sequence in a physical layer convergence protocol preamble to facilitate subsequent analysis.

### 2. Description of Related Art

With the increasing demand for data transmission and requirements of users for convenience, wireless transmission technology has emerged. Currently, wireless transmission technology is widely used in consumer electronics and industrial-grade electronic products. Common communication protocols have been developed for different needs of all of the electronic products, and facilitate interactive communication among electronic products. However, common communication protocols have standardized specifications, and thus, common communication protocols have limitations. In some applications, these limitations may affect the efficiency of wireless transmission.

### SUMMARY OF THE INVENTION

In some aspects, an object of the present disclosure is to, but not limited to, provides a frame format generation and analysis system and a frame format generation and analysis method that makes an improvement to the prior art.

An embodiment of the frame format generation and analysis system of the present disclosure includes a transmitting device and a receiving device. The transmitting device is configured to insert a signature sequence in a physical layer convergence protocol preamble, insert a remaining sequence between the signature sequence and a start frame delimiter, and transmit the physical layer convergence protocol preamble. The receiving device is configured to receive the physical layer convergence protocol preamble, and analyze whether the physical layer convergence protocol preamble includes the signature sequence, wherein if the physical layer convergence protocol preamble includes the signature sequence, the receiving device generates an activating signal for activating a user-defined protocol.

An embodiment of the frame format generation and analysis method of the present disclosure includes following steps: inserting a signature sequence in a physical layer convergence protocol preamble, and insert a remaining sequence between the signature sequence and a start frame delimiter, and transmitting the physical layer convergence protocol preamble by a transmitting device; and receiving the physical layer convergence protocol preamble, and analyzing whether the physical layer convergence protocol preamble includes the signature sequence by a receiving device, wherein if the physical layer convergence protocol preamble includes the signature sequence, the receiving device generates an activating signal for activating a user-defined protocol

Technical features of some embodiments of the present disclosure make an improvement to the prior art. The frame format generation and analysis system and the frame format generation and analysis method of the present disclosure utilize the transmitting device to insert the signature sequence in the physical layer convergence protocol preamble to facilitate subsequent analysis of the receiving device. If the receiving device analyzes that the physical layer convergence protocol preamble includes the signature sequence, the receiving device generates an activating signal for activating a user-defined protocol. In view of the above, the present disclosure can avoid the limitations of common communication protocols, thereby significantly improving the efficiency of wireless transmission.

These and other objectives of the present invention will no doubt become obvious to those of ordinary skill in the art after reading the following detailed description of the preferred embodiments that are illustrated in the various figures and drawings.

### BRIEF DESCRIPTION OF THE DRAWINGS

FIG. 1 shows an embodiment of a frame format generation and analysis system of the present disclosure.

FIG. 2 shows an embodiment a flowchart of a frame format generation and analysis method of the present disclosure.

FIG. 3 shows an embodiment of a physical layer convergence protocol (PLCP) preamble of the present disclosure.

FIG. 4 shows an embodiment of an operation diagram of a transmitting device of the present disclosure.

FIG. 5 shows an embodiment of a physical layer convergence protocol preamble of the present disclosure.

FIG. 6 shows an embodiment of an operation diagram of a receiving device of the present disclosure.

### DETAILED DESCRIPTION OF THE PREFERRED EMBODIMENTS

In order to improve the efficiency of wireless transmission being affected in some applications due to limitations of common communication protocols, the present disclosure provides a frame format generation and analysis system and a frame format generation and analysis method, which will be explained in detail as shown below.

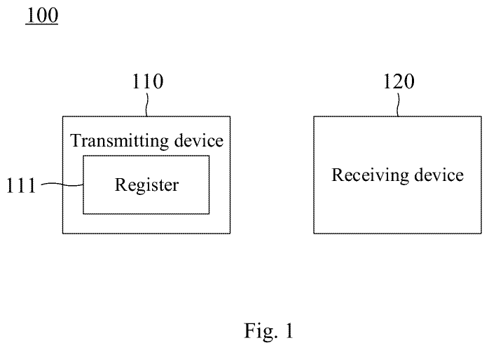

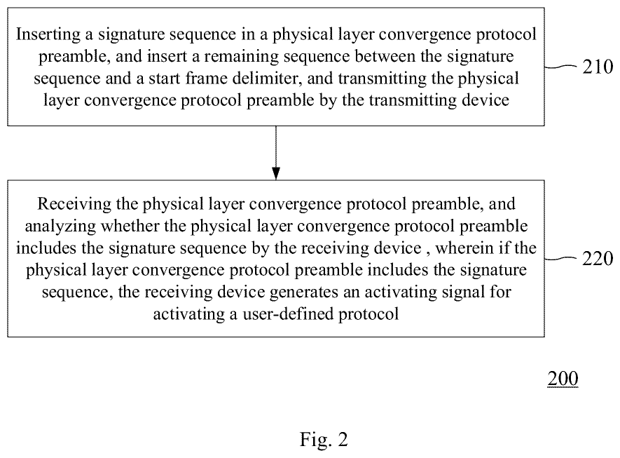

FIG. 1 shows an embodiment of a frame format generation and analysis system 100 of the present disclosure. As shown in the figure, the frame format generation and analysis system 100 includes a transmitting device 110 and a receiving device 120. For facilitating the understanding of operations of the frame format generation and analysis system 100, reference is made to FIG. 2. FIG. 2 shows an embodiment a flowchart of a frame format generation and analysis method 200 of the present disclosure. In some embodiments, the frame format generation and analysis system 100 and the frame format generation and analysis method 200 of the present disclosure can be utilized in IEEE 802.11b. However, the above-mentioned embodiment is merely utilized to describe one of the implementations, and the present disclosure is not limited thereto. In another embodiment, the frame format generation and analysis system 100 and the frame format generation and analysis method 200 of the present disclosure can be utilized in other technology based on actual requirements.

In step 210, inserting a signature sequence in a physical layer convergence protocol preamble, insert a remaining sequence between the signature sequence and a start frame delimiter, and transmitting the physical layer convergence protocol preamble by the transmitting device 110. In step 220, receiving the physical layer convergence protocol preamble, and analyzing whether the physical layer convergence protocol preamble includes the signature sequence by the receiving device 120. If the physical layer convergence protocol preamble includes the signature sequence, the receiving device 120 generates an activating signal for activating a user-defined protocol, which will be explained in detail as shown below.

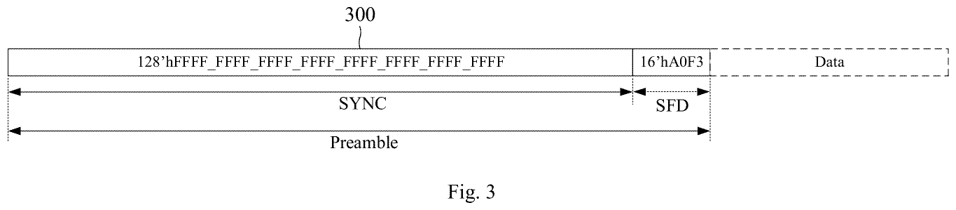

FIG. 3 shows an embodiment of a physical layer convergence protocol preamble 300 of the present disclosure. As shown in FIG. 3, the physical layer convergence protocol (PLCP) preamble 300 includes a synchronization sequence SYNC and a start frame delimiter SFD. In some embodiments, the length of the synchronization sequence SYNC can be 128 bits, and the synchronization sequence SYNC is all 1 sequence. Besides, the length of the start frame delimiter SFD can be 16 bits, and the start frame delimiter SFD can be h′AOF3.

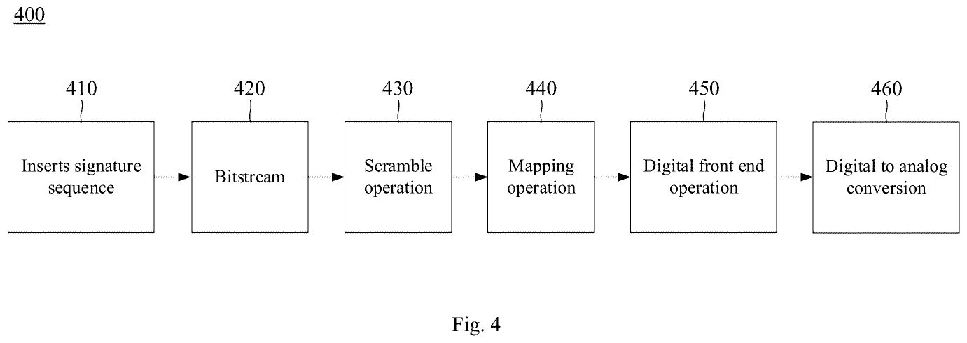

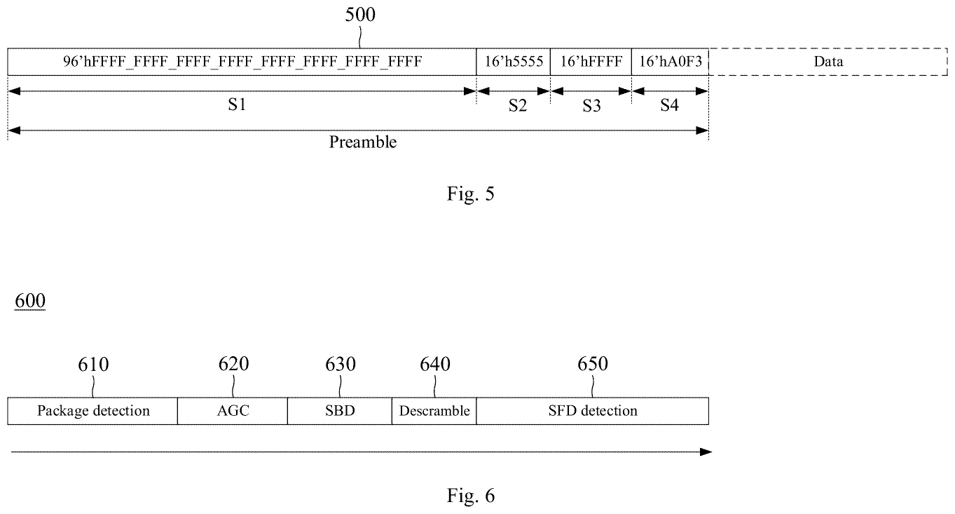

Reference is now made to both FIG. 4 and FIG. 5. FIG. 4 shows an embodiment of an operation diagram 400 of the transmitting device 110 of the present disclosure, and FIG. 5 shows an embodiment of a physical layer convergence protocol preamble 500 of the present disclosure. In step 410, compared to the embodiment in FIG. 3, the transmitting device 110 inserts the signature sequence S2 and the remaining sequence S3 in the physical layer convergence protocol preamble 500, and generates a bitstream having the above-mentioned frame format in step 420. Subsequently, the transmitting device 110 executes a scramble operation to the bitstream in step 430, executes a mapping operation to the bitstream in step 440, and executes a digital front end (DFE) operation (e.g., filtering) to the bitstream in step 450. Furthermore, the transmitting device 110 executes a digital to analog conversion to the bitstream in step 460, and transmits it to the receiving device 120.

In step 410, compared to the embodiment in FIG. 3, the transmitting device 110 of the present disclosure insert the signature sequence S2 in the physical layer convergence protocol preamble 500 for facilitating subsequent analysis of the receiving device 120 for activating a user-defined protocol, thereby avoiding the limitations of common communication protocols and significantly improving the efficiency of wireless transmission.

Besides, the transmitting device 110 further inserts the remaining sequence S3 between the signature sequence S2 and the start frame delimiter S4. It is noted that, for electronic products to identify the type of the physical layer convergence protocol preamble 500, the characters before the start frame delimiter S4 will be analyzed. Therefore, the present disclosure inserts the remaining sequence S3 before the start frame delimiter S4 to ensure that electronic products can correctly determine the type of the physical layer convergence protocol preamble 500.

In some embodiments, the physical layer convergence protocol preamble 500 includes the synchronization sequence S1, the signature sequence S2, the remaining sequence S3, and the start frame delimiter S4. The synchronization sequence S1, the signature sequence S2, the remaining sequence S3, and the start frame delimiter S4 are arranged from left to right in sequence.

In some embodiments, the synchronization sequence SI includes all 1 sequence. As shown in the embodiment of FIG. 5, the length of the synchronization sequence S1 is 96 bits, and the synchronization sequence S1 can be all 1 sequence.

In some embodiments, the signature sequence S2 can be an alternative bit sequence or all 0 sequence. For example, referring to FIG. 1, the register 111 of the transmitting device 110 can set the signature sequence S2 as an alternative sequence of 0 and 1 (e.g., 01 sequence or 10 sequence), or set the signature sequence S2 to be all 0 sequence. As shown in the embodiment of FIG. 5, the length of the signature sequence S2 can be 16 bits, and the signature sequence S2 can be h′5555, which in binary is an alternative bit sequence of 0101. In some embodiments, the length of the signature sequence S2 can be 16 bits, and the signature sequence S2 can be h′0000, which in binary is an all 0 sequence.

In some embodiments, the remaining sequence S3 includes all 1 sequence. As shown in the embodiment of FIG. 5, the length of the remaining sequence S3 can be 16 bits, and the remaining sequence S3 can be h′FFFF, which in binary is all 1 sequence. In some embodiments, the start frame delimiter S4 in FIG. 5 can be 16 bits, and the start frame delimiter S4 can be h′AOF3. However, the above-mentioned embodiment is merely utilized to describe one of the implementations, and the present disclosure is not limited to the embodiment in FIG. 5. In another embodiment, the lengths, the sequences, and the types of the synchronization sequence S1, the signature sequence S2, the remaining sequence S3, and the start frame delimiter S4 of the present disclosure can be adjusted adaptively based on actual requirements.

In some embodiments, the type of the physical layer convergence protocol preamble 500 can be a long physical layer convergence protocol (PLCP) preamble. However, the above-mentioned embodiment is merely utilized to describe one of the implementations, and the present disclosure is not limited thereto.

In some embodiments, referring to FIG. 1, the register 111 of the transmitting device 110 can set the time inserting the signature sequence S2, for example, the time can be 12 μs, 16 μs, 20 μs, or 24 μs. Besides, the register 111 of the transmitting device 110 can also set the time of the remaining sequence S3, for example, the time can be 16 μs, 24 μs, 32 μs, or 40 μs. Furthermore, the total time of the signature sequence S2 and the remaining sequence S3 can be 52 μs. In addition, the synchronization sequence S1 preceding the signature sequence S2 reserves a period of time, thereby preventing the receiving device 120 from missing the analysis of the signature sequence S2. However, the above-mentioned embodiment is merely utilized to describe one of the implementations, and the present disclosure is not limited thereto. In another embodiment, the time between the sequences can be adjusted adaptively based on actual requirements.

FIG. 6 shows an embodiment of an operation 600 diagram of the receiving device 120 of the present disclosure. As shown in FIG. 6, in step 610, the receiving device 120 executes a package detection to receive the package including the physical layer convergence protocol preamble 500. In step 620, the receiving device 120 executes an automatic gain control (AGC), and the receiving device 120 executes a symbol boundary detection (SBD) in step 630. Subsequently, the receiving device 120 executes a descramble operation in step 640 corresponding to the scramble operation in step 430, and the receiving device 120 executes a start frame delimiter (SFD) detection in step 650.

Refer is now made to both FIG. 5 and FIG. 6. In operation 600, the receiving device 120 executes the start frame delimiter (SFD) detection in step 650 before the period of the signature sequence S2 to ensure that the signature sequence S2 can be analyzed correctly.

In operation 600, the receiving device 120 would also analyze whether the physical layer convergence protocol preamble 500 includes the signature sequence S2. If the physical layer convergence protocol preamble 500 includes the signature sequence S2, the receiving device 120 generates the activating signal for activating the user-defined protocol. For example, if the receiving device 120 analyzes that the signature sequence S2 of the physical layer convergence protocol preamble 500 can be an alternative bit sequence or an all 0 sequence (for example, the signature sequence S2 can be an alternative sequence of 0 and 1 (e.g., 01 sequence or 10 sequence), or the signature sequence S2 can be an all 0 sequence), the receiving device 120 generates the activating signal for activating the user-defined protocol. In view of the above, the receiving device 120 of the present disclosure can analyze the physical layer convergence protocol preamble 500 for activating the user-defined protocol, thereby significantly improving the efficiency of wireless transmission.

In some embodiments, the receiving device 120 can transmit the activating signal to the medium access control (MAC) layer, and the medium access control layer activates the user-defined protocol. For example, the user-defined protocol can be a power adjustment protocol, a transmitting rate adjustment protocol, or a packet adjustment protocol. If the power adjustment protocol is active, the transmitting device 110 can increase TX power so as to enhance the transmitting distance of the transmitting device 110. If the transmitting rate adjustment protocol is active, the transmitting device 110 can adaptively adjust TX rate so as to enhance the transmission efficiency between the transmitting device 110 and the receiving device 120 for further preventing frequency jamming situations from occurring. If the packet adjustment protocol is active, the receiving device 120 can utilize the same signature sequence S2 mode to return response packet. The activation of the aforementioned user-defined protocols contribute to the successful transmission rate of the frame format generation and analysis system 100 of the present disclosure. However, the above-mentioned embodiment is merely utilized to describe one of the implementations, and the present disclosure is not limited thereto. In another embodiment, the user-defined protocol can be adjusted adaptively based on actual requirements.

It is noted that the present disclosure is not limited to the embodiments as shown in FIG. 1 to FIG. 6, it is merely an example for illustrating one of the implements of the present disclosure, and the scope of the present disclosure shall be defined on the bases of the claims as shown below. In view of the foregoing, it is intended that the present disclosure covers modifications and variations to the embodiments of the present disclosure, and modifications and variations to the embodiments of the present disclosure also fall within the scope of the following claims and their equivalents.

As described above, technical features of some embodiments of the present disclosure make an improvement to the prior art. The frame format generation and analysis system 100 and the frame format generation and analysis method 200 of the present disclosure utilize the transmitting device 110 to insert the signature sequence in the physical layer convergence protocol preamble to facilitate subsequent analysis of the receiving device 120. If the receiving device 120 analyzes that the physical layer convergence protocol preamble includes the signature sequence, the receiving device 120 generates an activating signal for activating a user-defined protocol. In view of the above, the present disclosure can avoid the limitations of common communication protocols, thereby significantly improving the efficiency of wireless transmission.

It is noted that people having ordinary skill in the art can selectively use some or all of the features of any embodiment in this specification or selectively use some or all of the features of multiple embodiments in this specification to implement the present invention as long as such implementation is practicable; in other words, the way to implement the present invention can be flexible based on the present disclosure.

The aforementioned descriptions represent merely the preferred embodiments of the present invention, without any intention to limit the scope of the present invention thereto. Various equivalent changes, alterations, or modifications based on the claims of the present invention are all consequently viewed as being embraced by the scope of the present invention.

What is claimed is:

1. A frame format generation and analysis system, comprising:
a transmitting device, configured to insert a signature sequence in a physical layer convergence protocol preamble, insert a remaining sequence between the signature sequence and a start frame delimiter, and transmit the physical layer convergence protocol preamble; and
a receiving device, configured to receive the physical layer convergence protocol preamble, and analyze whether the physical layer convergence protocol preamble comprises the signature sequence, wherein if the physical layer convergence protocol preamble comprises the signature sequence, the receiving device generates an activating signal for activating a user-defined protocol.

2. The frame format generation and analysis system of claim 1, wherein the signature sequence comprises one of an alternative bit sequence and an all 0 sequence.

3. The frame format generation and analysis system of claim 1, wherein the transmitting device comprises:
a register, configured to set the signature sequence to be a 01 sequence or a 10 sequence.

4. The frame format generation and analysis system of claim 1, wherein the remaining sequence comprises an all 1 sequence.

5. The frame format generation and analysis system of claim 1, wherein the physical layer convergence protocol preamble comprises a synchronization sequence, the signature sequence, the remaining sequence, and the start frame delimiter, wherein the synchronization sequence, the signature sequence, the remaining sequence, and the start frame delimiter are arranged in sequence.

6. The frame format generation and analysis system of claim 1, wherein the transmitting device comprises:
a register, configured to set a first period inserting the signature sequence and a second period of the remaining sequence, wherein the first period ranges from 12 μs to 24 μs, and the second period ranges from 16 μs to 40 μs.

7. The frame format generation and analysis system of claim 6, wherein the receiving device executes a start frame delimiter detection operation before the first period of the signature sequence.

8. The frame format generation and analysis system of claim 1, wherein the signature sequence comprises one of an alternative bit sequence and an all 0 sequence, and the receiving device is configured to analyze whether the physical layer convergence protocol preamble comprises one of the alternative bit sequence and the all 0 sequence.

9. The frame format generation and analysis system of claim 1, wherein the receiving device transmits the activating signal to a medium access control layer, and the medium access control layer activates the user-defined protocol.

10. The frame format generation and analysis system of claim 1, wherein the user-defined protocol comprises one of a power adjustment protocol, a transmitting rate adjustment protocol, and a packet adjustment protocol.

11. A frame format generation and analysis method, comprising:
inserting a signature sequence in a physical layer convergence protocol preamble, and insert a remaining sequence between the signature sequence and a start frame delimiter, and transmitting the physical layer convergence protocol preamble by a transmitting device; and
receiving the physical layer convergence protocol preamble, and analyzing whether the physical layer convergence protocol preamble comprises the signature sequence by a receiving device, wherein if the physical layer convergence protocol preamble comprises the signature sequence, the receiving device generates an activating signal for activating a user-defined protocol.

12. The frame format generation and analysis method of claim 11, wherein the signature sequence comprises one of an alternative bit sequence and an all 0 sequence.

13. The frame format generation and analysis method of claim 11, further comprising:
setting the signature sequence to be a 01 sequence or a 10 sequence by a register of the transmitting device.

14. The frame format generation and analysis method of claim 11, wherein the remaining sequence comprises an all 1 sequence.

15. The frame format generation and analysis method of claim 11, wherein the physical layer convergence protocol preamble comprises a synchronization sequence, the signature sequence, the remaining sequence, and the start frame delimiter, wherein the synchronization sequence, the signature sequence, the remaining sequence, and the start frame delimiter are arranged in sequence.

16. The frame format generation and analysis method of claim 11, further comprising:
setting a first period inserting the signature sequence and a second period of the remaining sequence by a register of the transmitting device, wherein the first period ranges from 12 μs to 24 μs, and the second period ranges from 16 μs to 40 μs.

17. The frame format generation and analysis method of claim 16, further comprising:
executing a start frame delimiter detection operation before the first period of the signature sequence by the receiving device.

18. The frame format generation and analysis method of claim 11, wherein the signature sequence comprises one of an alternative bit sequence and an all 0 sequence, wherein receiving the physical layer convergence protocol preamble, and analyzing whether the physical layer convergence protocol preamble comprises the signature sequence by the receiving device comprises:
receiving the physical layer convergence protocol preamble, and analyzing whether the physical layer convergence protocol preamble comprises one of the alternative bit sequence and the all 0 sequence by the receiving device.

19. The frame format generation and analysis method of claim 11, wherein if the physical layer convergence protocol preamble comprises the signature sequence, the receiving device generates the activating signal for activating the user-defined protocol comprises:
if the physical layer convergence protocol preamble comprises the signature sequence, transmitting the activating signal to a medium access control layer by the receiving device, and the medium access control layer activates the user-defined protocol.

20. The frame format generation and analysis method of claim 11, wherein the user-defined protocol comprises one of a power adjustment protocol, a transmitting rate adjustment protocol, and a packet adjustment protocol.
